(19) United States
(12) Patent Application Publication
(10) Pub. No.: US 2004/0025858 A1
(43) Pub. Date: Feb. 12, 2004

(54) Crack/joint inducers for portland cement concrete pavement and slabs

(76) Inventors: Ernest J. Barenberg, St. Joseph, IL (US); Barry J. Dempsey, White Heath, IL (US)

Correspondence Address: Michael Berns, Maloney Parkinson & Berns, 135 West Main Street, Urbana, IL, 61801, US

(21) Appl. No.: 10/629,225

(22) Filed: Jul. 29, 2003

Related U.S. Application Data
(60) Provisional application No. 60/399,288, filed on Jul. 30, 2002.

(51) Int. Cl. B28D 1/00

(52) U.S. Cl. 125/1

(57) ABSTRACT

A film material is used to create a concrete control joint. A thin plastic film creates a plane of weakness in the concrete to control or induce cracking at desirable locations and directions. A tool for installing the film inserts the film material into fresh concrete.

### CROSS-REFERENCE TO RELATED APPLICATION

This application claims the benefits of the earlier filed U.S. Provisional App. Ser. No. 60/399,288, filed Jul. 30, 2002, which is incorporated by reference for all purposes into this application.

### FIELD OF INVENTION

The present invention relates to the installation of a plastic strip material into fresh Portland cement concrete to control cracking. After the concrete is poured, the water in the material reacts in hydration. As the water is used up, the concrete shrinks causing it to crack. The time and location of the resulting cracks depend on the rate of set, the amount of water in the concrete mix, and climatic conditions at the time of pouring.

### DESCRIPTION OF THE PRIOR ART

Cracking of the concrete is inevitable. To control the location and appearance of the cracks, joints are usually sawn or formed in the fresh concrete. The joints may be tooled into wet concrete, sawn when the concrete begins to harden, or most commonly, sawn after the concrete has hardened overnight. The joint forms a thinner strip of concrete, creating a weakened section where the crack is induced to form along, rather than forming an uncontrolled jagged crack. The spacing of the joints is important to prevent uncontrolled cracking at locations where there are no formed or sawn joints.

Timing of sawing joints in the concrete is a major problem for construction. If the sawing is done too early, spalls occur along the joints. If the sawing is done too late, the concrete cracks before the saw cuts are complete and random spacing and irregular cracks result. In many cases, the ideal time to saw the concrete slabs is approximately 6 to 8 hours after the concrete is cast. This forces much of the sawing to occur after most of the concrete placement crew is gone from the jobsite. The crew may pay overtime for someone to saw-cut the joints, or wait until the next morning, when the concrete may have already cracked.

A common method of cutting joints into concrete prior to the concrete becoming completely hardened is shown in U.S. Pat. No. 5,803,071 to Chiuminatta and Chiuminatta.

Tooled and sawn joints may need to be maintained to protect the joint. Water may seep into the joints. When cars pass over joints, the wheels may make undesirable noise.

As an alternative to tooled or saw-cut joints, preformed plastic strips can be pressed into the wet concrete after it has been poured but before it has cured. These strips are costly and difficult to place in the proper location and alignment. A typical plastic joint strip is shown in U.S. Pat. No. 5,548,009 to Dahowski.

### SUMMARY OF THE INVENTION

If a narrow plastic strip is inserted into the concrete prior to the final finish on the concrete surface, the plastic strip will induce a crack directly over where the plastic strip was inserted. If the plastic strip is flexible, the strip will deform slightly around the aggregate materials in the concrete to create an interlock along the formed crack. The aggregate interlock is critical to maintain greater load transfer across the crack/joint.

The plastic film creates a weakened plane where the crack will form, similar to a tooled or sawcut joint. As the film forms a weakened plane, the concrete flows back against the plastic film to heal together. Rather than the ⅛″ thick void of a tooled or sawn joint, the joint formed by the film is only thousandths of an inch thick. With vibration of the concrete during installation of the film, the concrete will flow against the film. The top of the film may be inserted below the surface fo the concrete. The concrete forms over the top of the film to make the joint visible at the surface until the crack propagates to the surface.

It is therefore an object of the invention to provide a concrete joint formed by a film material.

It is further an object of the invention to provide a tool to install a film material joint in concrete.

It is further an object of the invention to provide a method of placing concrete with a film material to induce cracking.

It is further an object of the invention to provide a film material for embedding in concrete to create a plane of weakness to control cracking.

### BRIEF DESCRIPTION OF THE DRAWINGS

FIG. 1. is a cross sectional view of (1)saw-cut, (2)tooled, (3)pre-formed strip, and (4)plastic film joints.

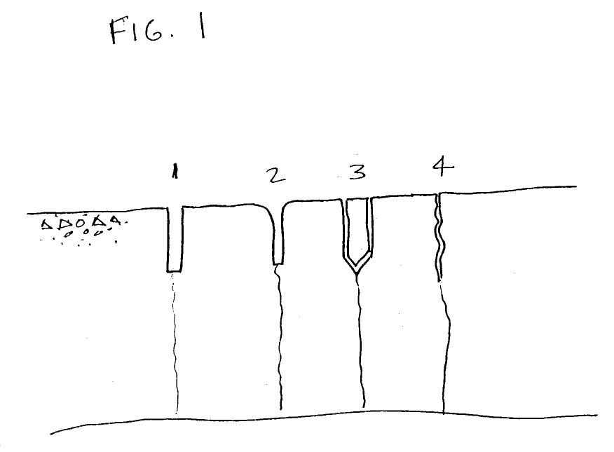

FIG. 2. is a side view of an embodiment of the shoe device.

FIG. 3 is a top view of an embodiment of the shoe device.

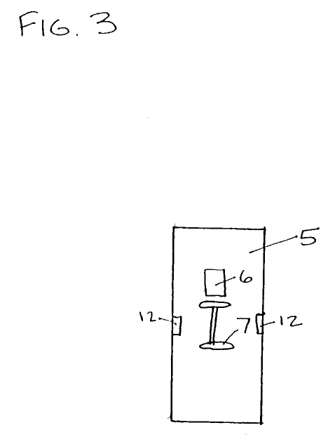

FIG. 4 is a perspective view of an embodiment of the shoe device.

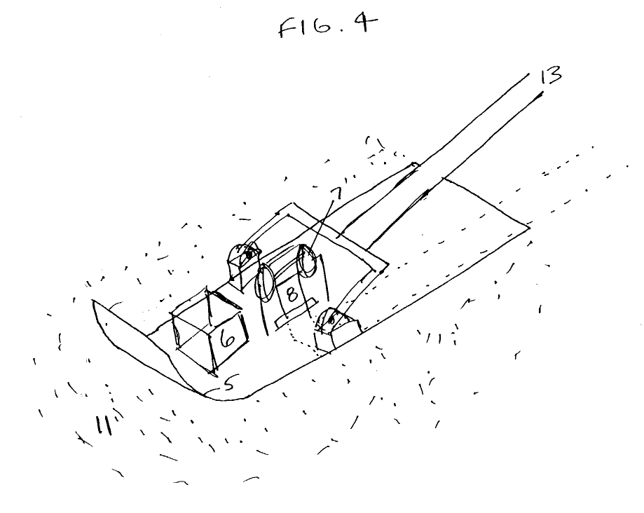

### REFERENCE NUMERALS USED IN THE DRAWINGS

1. Saw-cut joint (prior art)

2. Tooled joint (prior art)

3. Pre-formed strip joint (prior art)

4. Plastic film joint

5. Plate leading edge

6. Vibrator

7. Spool

8. Film

9. Film rotator

10. Plate

11. Fresh concrete

12. Handle anchor

13. Handle

### DETAILED DESCRIPTION OF THE INVENTION

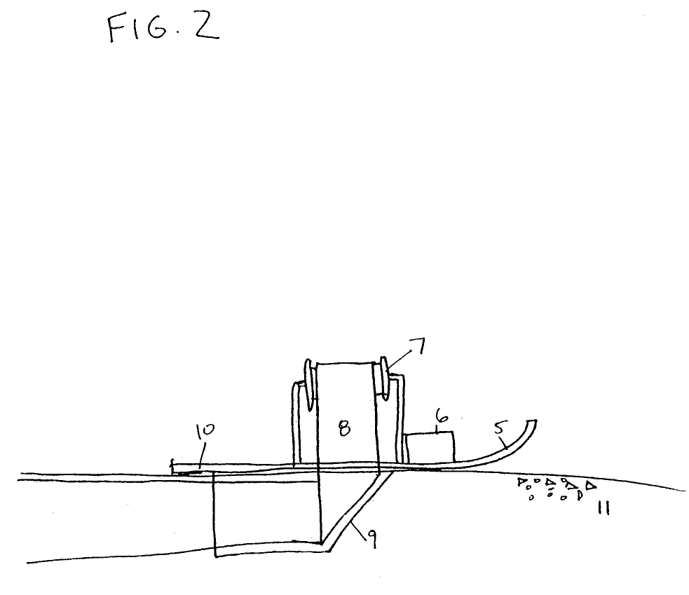

A shoe device is provided for installing a plastic film 8 vertically in fresh, fluid concrete 11. Referring to FIG. 2, a flat plate 10 is provided to float over fresh concrete. This plate 10 is similar to finishing float tools. The plate 10 includes a leading edge 5 to allow the plate 10 to travel over wet, unfinished concrete. Attached to the bottom side of the plate 10 is a film rotator housing 9. A film material 8 is held on a roll 7 attached to the top of the plate 10. The film material 8 is fed through a slit opening in the plate 10 and onto a roller inside the film rotator housing 9. This is preferably at an approximate 45 degree angle to the surface of the concrete 11 to allow the film rotator housing 9 to pass through the fresh concrete 11 to form a tooled joint. The film rotator housing 9 may be adjustable in depth and would preferably extend approximately 4 inches into the concrete.

It may be beneficial to place the film material 8 slightly below the surface of the concrete 11. This would provide the same plane of weakness to initiate the crack, but would make the film material 8 invisible and provide the smallest possible crack at the surface of the concrete 11.

As the fresh concrete 11 flows back together, it fills in the tooled joint and against the sides of the film 8. The film 8 prevents aggregate in the Portland cement concrete from creating an interlocking bond and the narrow gap created produces a weak location in the concrete. This weak spot is where the concrete should crack. Cracks are then controlled, but a narrow as possible. The surface of the concrete is thus smoother than prior art methods of forming these joints. This is favorable for a driving surface, walking, roller skating, and many other concrete uses.

A vibrator 6 may be included to help the film rotator housing 9 get through the fresh concrete 11. The vibration also helps to heal the fresh concrete 11 and form around the sides of the film 8. A probe on the vibrator 6 could extend into the concrete 11 to place the vibration right at the leading edge of the film rotator housing 9. It also may be beneficial to mount the vibrator 6 on a hard rubber block to spread and diffuse the vibrations. A switch could also be provided in the handle to control the operation and speed of the vibrator 6.

In one embodiment of the invention, a handle 13 is attached to the plate 10 to push the invention through the concrete 11. A long handle extension could be provided for large concrete pours. A user could follow close behind the concrete pour to quickly install the film 8 and create the joints. This would reduce the overtime necessary and help prevent the situation where the concrete forms cracks prior to making saw-cut joints.

The invention may also be incorporated into the mechanics of a paving machine. Large paving machines are often used for large areas of concrete. A paving machine is shown in U.S. Pat. No. 3,970,405 to Swisher et al. This could be utilized for longitudinal or transverse joints.

The film material is preferably a polyethylene material, or similar plastic. Numerous plastic or elastomeric materials may be utilized. Polyethylene approximately 4 inches tall and approximately 4 mil thick has proven satisfactory. A suitable material may be available from Rutan Poly Industries, Inc., 39 Siding Place, Mahwah N.J. 07430. Thicker film materials provide better separation of the concrete aggregate. It may be beneficial to have thinner film material to allow the aggregate to deform the film material creating a greater resistance to movement between the adjacent pieces of concrete.

It is also possible to utilize a mesh material, or place holes in the film material to allow small amounts of concrete material to pass through the holes. A suitable mesh could be something similar to POLYMESH brand by Protek, 19 N. 2d St. Suite 206, San Jose, Calif. 95113.

To provide a self-sealing joint material, it may be helpful to utilize a sealant strip as the film material. A similar product is the GELTEK brand sealant strip manufactured by Raychem.

Although the invention has been described with reference to these preferred embodiments, other embodiments can achieve the same results. Variations and modifications of the present invention will be apparent to one skilled in the art and the above disclosure is intended to cover all such modifications and equivalents.

We claim:

1. A poured concrete material having a plastic film embedded in the concrete to control cracking.

2. The poured concrete material according to claim 1, wherein the plastic film has a thickness between 1 mil and 10 mil.

3. The poured concrete material according to claim 1, wherein the plastic film material extends from about the top surface of the concrete to a depth of from one quarter of the thickness to the full depth.

4. A method of placing concrete comprising the steps of:
pouring a section of concrete;
inserting a film material into the concrete before it completely hardens;
wherein the film material forms a plane of weakness in the concrete after hardening to control cracking.

5. The method of placing concrete according to claim 4, wherein the film material has a thickness between 1 mil and 10 mil.

6. The method of placing concrete according to claim 4, wherein the film material extends from about the top surface of the concrete to a depth of from one quarter of the thickness to the full depth.

7. A joint material adapted to be embedded in concrete to control cracking comprising:
a film material whereas the film material creates a plane of weakness in the concrete.

8. The joint material according to claim 7, wherein the film material has a thickness between 1 mil and 10 mil.

9. The joint material according to claim 7, wherein the film material extends from about the top surface of the concrete to a depth of from one quarter of the thickness to the full depth.

10. A tool for embedding a film material inside concrete comprising:
a plate for contacting the upper surface of the concrete;
a spool for storing the film material prior to embedding; and
a housing for inserting the film material under the upper surface of the concrete.

11. The tool for embedding a film material inside concrete according to claim 10 further comprising vibration means to aid in inserting the film material.

12. A concrete control joint in concrete comprising a film material embedded in the concrete.

13. The concrete control joint according to claim 12, wherein the film material has a thickness from 1 mil to 10 mil.

14. The concrete control joint according to claim 12 wherein the film material extends vertically within the concrete from the top surface to a depth from one-quarter of the thickness of the concrete to the full depth.
